(19) United States
(12) Patent Application Publication
(10) Pub. No.: US 2008/0189429 A1
(43) Pub. Date: Aug. 7, 2008

(54) APPARATUS AND METHOD FOR PEER-TO-PEER STREAMING

(75) Inventor: Behram Mario DaCosta, San Diego, CA (US)

Correspondence Address: O'BANION & RITCHEY LLP/ SONY ELECTRONICS, INC., 400 CAPITOL MALL, SUITE 1550, SACRAMENTO, CA, 95814, US

(73) Assignees: Sony Corporation, Tokyo (JP); Sony Electronics Inc., Park Ridge, NJ (US)

(21) Appl. No.: 11/670,879

(22) Filed: Feb. 2, 2007

(51) Int. Cl. G06F 15/16

(52) U.S. Cl. 709/231

(57) ABSTRACT

A method and apparatus of communicating streaming content through the Internet. Elements of streaming content are segmented and stored across a plurality of network-enabled computer devices coupled to the Internet. Each segment of the streaming content contains a plurality of data packets and an identifier for the segment. A client application accesses a streaming content element after first determining its availability on the network, such as according to a list. Requests for segments of the streaming content element are made by the client to selected devices based on information about service latency, such as determined in response to server status information, negotiation, estimation, and/or measurement. Real-time connectivity is established through which the packets of the segments are retrieved from the sending devices. The packets and segments are prepared and ordered into a streaming output of said given content element.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to streaming media, and more particularly to peer-to-peer streaming media over a wide area network.

2. Description of Related Art

Communication of media content (e.g., video or audio) over the Internet has become commonplace between clients and servers, and also between peers which operate as clients when requesting media content, or as servers when servicing a request for media content. The media content can be played back in response to either a downloading technique or a streaming media technique.

In a download technique, media is communicated according to conventional file transport mechanisms in which a user must download the entire media content, such as a video or audio file, at the prevailing transmission rate which is stored onto the local hard disk drive (or other high-capacity data storage device) prior to viewing the media content, as retrieved from the data storage device. The technique requires the user to wait for a period of time, perhaps hours, while the download progresses through completion. The time required for the download to complete depends on both bandwidth and latency factors. It will be appreciated that ‘bandwidth’ can also be considered in terms of average inter-packet delay, and for some networking protocols in terms of average packet latency. Considering communication from a peer device, it will be appreciated that the download from the personal computer (PC) of a user may progress at a rate of only 50 Kbps, wherein retrieval of a media content element could require several hours. After download completion, the viewer may view the media content retrieved from the hard drive, such as at a playback rate of 1 Mbps. Downloading in this case, even with the use of a broadband link, could still involve a substantial, and largely indeterminate, delay as many prospective viewers may be also attempting to download the file at the same time.

One application utilizing an improved media downloading technique is called BitTorrent™. Bit Torrent is a peer-to-peer (P2P) protocol which allows sharing of media content over the Internet in a fairly reliable and inexpensive manner as it does not require the use of massive centralized servers. However, BitTorrent cannot be used for streaming, as it can download only complete files, and does not operate in real-time.

BitTorrent does not download file contents in the order of the data within the file, but instead downloads data across different sections of the file in parallel from several hosts. Hence the first five seconds (5 S) of the file may download after the last five seconds (5 S) of the file, and hence the entire file must typically be downloaded before starting to view the file.

In response to the delays associated with downloading and to more readily control content distribution, “streaming media” techniques have been created in which media data is played or otherwise utilized, as the data streams into the requesting client. A number of problems exist with these streaming media approaches in that the bandwidth of the infrastructure supporting the Internet stream must exceed the rate at which the media is played (unless virtually all of the media element is first buffered, in which case latency of initial playback is increased), which is a difficult requirement to overcome by utilizing anything other than large dedicated servers. In addition, the streaming server must have adequate resources for CPU, network processing, and so forth.

Other solutions exist which stream media content by assuming that all viewers are synchronized in their viewing, wherein the content cannot be viewed on-demand. Additional problems with these streaming techniques include user interruption if one of the “upstream” user nodes suddenly leaves or otherwise becomes unavailable.

Still other workarounds can be found, such as where the user uploads the media file, which is to be shared, to a server provided by the internet-service provider (ISP) or content delivery network (CDN), wherefrom the file is shared from that location. However, a number of disadvantages still remain, in particular: (a) the ISP must provide substantial processor resources and storage as there potentially exists any number of users that may want to share the video files; (b) total storage space on the network is not optimized since the hard drive of the user devices (i.e., network-enabled PC) is not utilized; and (c) the web server of the ISP may be overwhelmed by requests, or paths to the ISP may become bottlenecked, or the ISP may crash or otherwise become unavailable.

The typical issues which arise with streaming media are now highlighted in the following scenario. Consider a scenario in which User_A would like to stream a movie they have made (e.g., encoded at 1 Mbps in AVC codec) to others on the Internet, such as using broadband network infrastructure. Assuming that User_A places the movie on their network-enabled device (e.g., personal computer—PC) acting as a server (e.g., peer-to-peer mode), and someone else on the Internet, such as User_B, attempts to view the movie as a real-time stream, wherein the following problems will likely arise:

(a) The broadband link between the PC of User_A and his ISP may offer a bandwidth of only 700 Kbps. Hence User_B is unable to view the movie of User_A in real-time since the stream of User_B requires a bandwidth of 1 Mbps. If a total of two people in addition to User_B attempt to view the stream, then at least 3 Mbps is required. If one thousand viewers attempt to view the stream from the Internet, then 1 Gbps of bandwidth is required.

(b) The interconnections may not support the needed bandwidth for communicating the stream. It should be noted that the necessary bandwidth is not only required on the link between User_A and their ISP, but is also required between the different routers on the ISP of User_A, and between routers on the Internet between User_A and User_B.

(c) In addition, the CPU of User_A must have adequate CPU power to stream 1,000 different streams, wherein the disk drive of User_A must support adequate throughput, as well as other issues. This would be far in excess of the capabilities of a typical personal computer at the present time.

(d) Crashes or even changes in service bandwidth effect viewing by the client devices. Even in a situation in which the PC of User_A manages to serve the content element to all client requesters, the viewers will lose their connections and/or viewing if the bandwidth available for servicing the requests drops (i.e., User_A commences an Internet search), or the PC of User_A crashes, loses connection to the ISP, or the ISP has a service fault, and so forth.

It can be seen that many problems arise with the use of existing streaming technology. In addition, situations arise in which a user would like to download a file while the user views the content as a stream in real-time. The existing technology does not allow a user to stream a remote file to themselves in real-time in a manner that is reliable while not placing an extensive burden on any single Internet node or path.

Accordingly, a need exists for a method of performing real-time peer-to-peer streaming which is not subject to the performance bottlenecks and failure intolerance of current approaches. These needs and others are met within the present invention, which overcomes the deficiencies of previously developed downloading and streaming access methods.

### BRIEF SUMMARY OF THE INVENTION

A method of performing peer-to-peer streaming is described which is in the form of a real-time peer-to-peer protocol that allows streaming of content over the Internet. Aspects of this invention can also be utilized to improve streaming reliability of Internet links other than peer-to-peer (P2P), as well as to improve streaming performance in Home Networks.

The present invention is preferably implemented as executable programming residing in both the client and server sides of the peer-to-peer interaction. It will be appreciated that devices in a peer-to-peer network operate as client or server depending on the transaction. For the sake of simplicity, the device requesting a media content element will be generally referred to herein as a client, while the devices delivering at least portions of the media content element are generally referred to as servers. Implementation involves the use of server programming that runs on one or more remote devices to provide a requested stream to client programming that is configured to run on a device through which a stream has been requested.

The media content element is segmented into a plurality of segments, which may be encoded using erasure codes, such as fountain codes. Each segment contains a plurality of packets whose composition is determined by the transmission medium and network protocol. In responding to segment requests, each server selects the packets from each segment and transmits those packets using internet protocols (IP), such as RTP. Packet selection for transmission may be according to a fixed order, random order, a selected mode, conditional, and so forth. Programming within the servers is preferably configured for storing segments of a media content element, communicating status and similar information from which latency may be estimated, handling segment requests, and transmitting packets of a segment to the requesting client.

Now turning to the client side, prior to requesting a media content element the client must determine where the content is available, such as obtaining this information from an availability list (or other data structure).

At the client end, the received packets are decoded and collated to form the media content element. The client may initiate connections with different servers depending on the transmission rates of the servers. In another embodiment of the invention, the transmission redundancy is reduced by using distributed RTP (described in a later section).

Programming executable within a client, or client mode, is more complex in that the client orchestrates which servers to use based on performance data, makes requests accordingly, handles errors, collates the received packets for the segments, and outputs the streaming media. It will be appreciated that typical output is to a display, although the mechanisms are applicable to any form of output.

As an aid to understanding the present invention, information follows about some of the terms utilized within the specification and claims, however, it is to be appreciated that these are provided for convenience and not as a substitute for other recitations within the specification and claims.

“Internet”, or “the Internet” are terms referring to a wide-area inter network which usually utilizes packet based IP protocols (Internet Protocols). The Internet allows unique addressing amongst devices (computers) interconnected over the Internet network. The term Internet has come to mean a specific wide area network providing worldwide IP connectivity, as a “network of networks” that consists of numerous (i.e., millions) of small networks (e.g., domestic, academic, business, and government networks), which taken together carry various services and information, such as including electronic mail, online chat, file transfer, and the interlinked Web pages and other documents of the World Wide Web. It should be appreciated, however, that the communications described herein as applied to “the Internet” is also applicable to similar networks that do not necessarily have worldwide connectivity, such as within private nets (i.e., DARPA net, and subnets of the Internet).

“Peer-to-peer” (P2P) is a term that is utilized herein to represent a type of transient Internet network that allows a group of computer users with the same networking program to connect with each other and directly access content files from one another, such as accessing a public area of the hard drive within another peer. This recent usage of the term “peer-to-peer” describes applications in which users exchange files with each other directly or through a mediating server. Peer-to-peer is a communications model in which each party has the same capabilities and either party can initiate a communication session. Another model with which it might be contrasted includes the client/server model. It may be considered that by implementing peer-to-peer communications, each peer device is given both server and client capabilities, depending on the transaction type and direction. It will be appreciated, according to the above, that the terms “client” and “server” as used herein are with respect to the function being performed for a given communication, and that peer devices can operate as clients, servers, or more typically as both clients and servers.

“Streaming media” is media that is utilized (e.g., heard or viewed) while it is being delivered. The term “streaming” is more a property of the delivery mechanism than the media itself. The term is usually applied to media distributed over computer networks, such as the Internet. The word “stream” is also used as a verb in many cases to describe the process of delivering streaming media.

“Real-time Transport Protocol (RTP)” is an Internet Standard protocol (RFC 1889) for the transport of real-time video or voice data. The protocol specifies a way for programs to manage the real-time transmission of multimedia data over either unicast or multicast network services. Originally directed for supporting video conferences with multiple, geographically dispersed participants. RTP is commonly used in Internet telephony applications. RTP does not in itself guarantee real-time delivery of multimedia data (since this is dependent on network characteristics); it does, however, manage the arrival of packet data. Typically, the RTP protocol executes on top of the User Datagram Protocol (UDP), although it can use other transport protocols. RTP components include: a sequence number, which is used to detect lost packets; payload identification, which describes the specific media encoding so that it can be changed if it has to adapt to a variation in bandwidth; frame indication, which marks the beginning and end of each frame; source identification, which identifies the originator of the frame; and intramedia synchronization, which uses timestamps to detect different delay jitter within a single stream and compensate for it.

“Segmented file” is a term used herein to describe separating a streaming content element (i.e., file) into a plurality of pieces, or segments, each of which contains a plurality of data packets. An identifier is incorporated within each segment identifying the position of the segment within the original streaming file. The mechanism of segmentation can be performed in a number of alternative ways with fixed or variable lengths. It is preferable that all the streaming content elements are segmented in the same manner to optimize efficiency, although this is not strictly necessary.

“Erasure codes” provide a mechanism for transforming a message of n packets into a message with >n packets, allowing the original message to be recovered from any subset of the latter packets. This mechanism provides a measure of data redundancy.

“Fountain codes” are often referred to as “rateless erasure codes” which transform an n packet message into a practically infinite encoded form. Encoded symbols can be generated ad infinitum and the presence of a certain number of them is sufficient to recover the message. With fountain encoding, the source data transmitted can be reconstructed intact from any subset of the received encoded packets approximately equal in total size to the source data. Several types of fountain erasure codes exist, including Tornado codes, which are well-suited for use with real-time applications having limited computations resources. Considering a case with m input binary vectors, a fountain code can produce almost any number of independent output binary vectors, such that the original m input binary vectors can be regenerated from a number of output vectors, in which the number of output vectors is somewhat greater in number than the m input binary vectors in the lossless case, with more vectors required in the lossy case. The total number of output vectors is dependent on the rate of transmission loss.

The invention is amenable to being embodied in a number of ways, including but not limited to the following descriptions.

One embodiment of the invention can be generally described as an apparatus for collecting streaming content over the Internet, comprising: (a) means for a client to determine the availability of a given streaming content element (e.g., list or query), within a plurality of peer devices configured for communicating with the client over the Internet; (a)(i) wherein the given streaming element is retained within the plurality of peer devices as a plurality of segments, each of which contains a plurality of data packets and a segment identifier; (b) means for requesting the segments of the given content element from any of the plurality of peer devices based on transmission performance (e.g., measured and/or estimated); (c) means for establishing real-time connectivity (e.g., use of a real-time transport protocol) with one or more of the peer devices, from within the plurality of peer devices, from which are collected the packets within each of the segments of the given streaming content element; and (d) means for preparing and ordering the collected packets and segments into a non-segmented streaming output of the given streaming content element, such as decoding the packets and collating the segments.

The apparatus for collecting streaming content is preferably implemented as programming for requesting and collating segmented media content from other devices over the Internet. The Internet connection is a worldwide area network that utilizes IP protocols for communicating packets between network devices. The client and server preferably being network-enabled computer devices configured for utilizing a peer-to-peer protocol that allows streaming of content elements over the Internet.

Requests for the segments of the media content are generated in response to transmission performance which can be determined in response to: (a) status information from the server, (b) performance measurements, (c) negotiation for communication modes/priority, (d) estimations based on one or more factors, or any desired combination thereof.

Variations of these embodiments exists, such as with regard to the use and type of encoding utilized. For example the segments and/or data packets can be encoded prior to transmission, wherein the means for preparing and ordering the collected packets and segments is configured for decoding the packets and collating the segments into a streaming output of the given streaming content element. The encoding can comprise erasure codes, fountain code encoding, or other mechanisms for improving message recovery. In addition, according to a distributed RTP implementation, the data packets are numbered utilizing a global packet numbering scheme in which identical packet portions from the original media can be detected by comparing their respective packet identifiers, wherein unnecessary packet duplications and packet collection processing can be reduced.

The apparatus can also be described as programming executable on a network-enabled computer device configured for communicating with a plurality of other network-enabled computer devices over the Internet. The network computer devices (client or server side) can comprise any electronic device configured for communicating media content elements over the Internet (e.g., personal computers—PCs, personal network devices, network-enabled cellular phones, network-appliances, and so forth).

One implementation of the present teachings is a method of communicating streaming content through the Internet, comprising: (a) storing a given streaming content element within a plurality of network-enabled computer devices configured for communicating over the Internet; (a)(i) wherein the given streaming element is retained within the network-enabled computer devices as a plurality of segments, each of which contains a plurality of data packets and a segment identifier; (b) determining the availability of the given streaming element within the plurality of network-enabled computer devices; (c) requesting the segments of the given content element from selected network-enabled computer devices within the plurality of network-enabled computer devices in response to estimated and/or measured service latency (or throughput) of the network-enabled computer devices; (d) establishing real-time connectivity with the selected network-enabled computer devices from which are collected the packets within each of the segments of the given content element; and (e) preparing and ordering the collected packets and segments into a streaming output of the given content element.

The present invention can provide a number of beneficial aspects which can be implemented either separately or in any desired combination without departing from the present teachings.

An aspect of the invention is to provide a peer-to-peer protocol that allows streaming of content over the Internet.

Another aspect of the invention is to provide a system in which a client can collect portions of a given streaming content element from each of a number of different peers configured for communication over the Internet.

Another aspect of the invention is to provide a system in which a server, or peer acting in the capacity of a server, hosting a given content element is not required to support the cumulative download bandwidth of a plurality of clients, which are instead supported across a plurality of peer network devices.

Another aspect of the invention is to provide a system in which a client requester is configured to track the availability of a given streaming element across a plurality of peers.

Another aspect of the invention is to provide a system in which a client requester is configured to track the availability of a given streaming element utilizing a separate device or server on the network, such as one dedicated to this task.

Another aspect of the invention is to provide a system in which a client requester is configured to track the server latency across a plurality of peers capable of supplying segments of a given streaming element.

Another aspect of the invention is to provide a system in which a streaming content element is divided into a plurality of segments which can be requested and retrieved from different peers on the network.

Another aspect of the invention is to provide a system in which each segment of a streaming content element is configured to include a segment identification to allow the segments to be collected in a proper order prior to streaming output.

Another aspect of the invention is to provide a client program that collates the streaming content from a list of one or more servers.

Another aspect of the invention is to provide a peer-to-peer real-time file sharing program that provides mechanisms to ensure that the entire file is available on a new host upon which it has already been viewed, and to encourage sharing of the file with other peers from that new host.

Another aspect of the invention is to provide a system in which multiple servers transmit encoded packets of the streaming content using IP protocols without conflict.

Another aspect is for each segment to be encoded using erasure codes such as Fountain codes prior to packetization and transmission from the server.

Another aspect of the invention is to provide a system in which real-time connections are established with one or more servers based on their transmission performance.

Another aspect of the invention is to provide a system in which distributed RTP creates packets of the streaming content for reducing the transmission redundancy.

Another aspect of the invention is to provide a distributed RTP mechanism utilizing a global packet numbering scheme to readily identify duplicate packets and to speed packet assembly at the receiver.

A still further aspect of the invention is to provide a mechanism for collecting packets, which comprise a streaming media element, while minimizing drop-outs when packets are not available as a media stream is being output.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a system configured for retrieving streaming multimedia according to an aspect of the present invention, showing a plurality of devices communicating over the Internet.

FIG. 2 is a flowchart of a method for retrieving streaming multimedia according to an aspect of the present invention.

FIG. 3 is a flowchart of a method for retrieving streaming multimedia according to an aspect of the present invention, and showing selective segment requests based on latency.

FIG. 4 is a block diagram of a network over which streaming multimedia is being viewed and stored according to an embodiment of the present invention.

FIG. 5 is a block diagram of retrieval from multiple hosts of multimedia using fountain codes according to an aspect of the invention, showing the multimedia which has been segmented and packetized.

FIG. 6 is a block diagram of retrieval from multiple hosts of multimedia using distributed RTP without fountain codes according to an aspect of the invention.

### DETAILED DESCRIPTION OF THE INVENTION

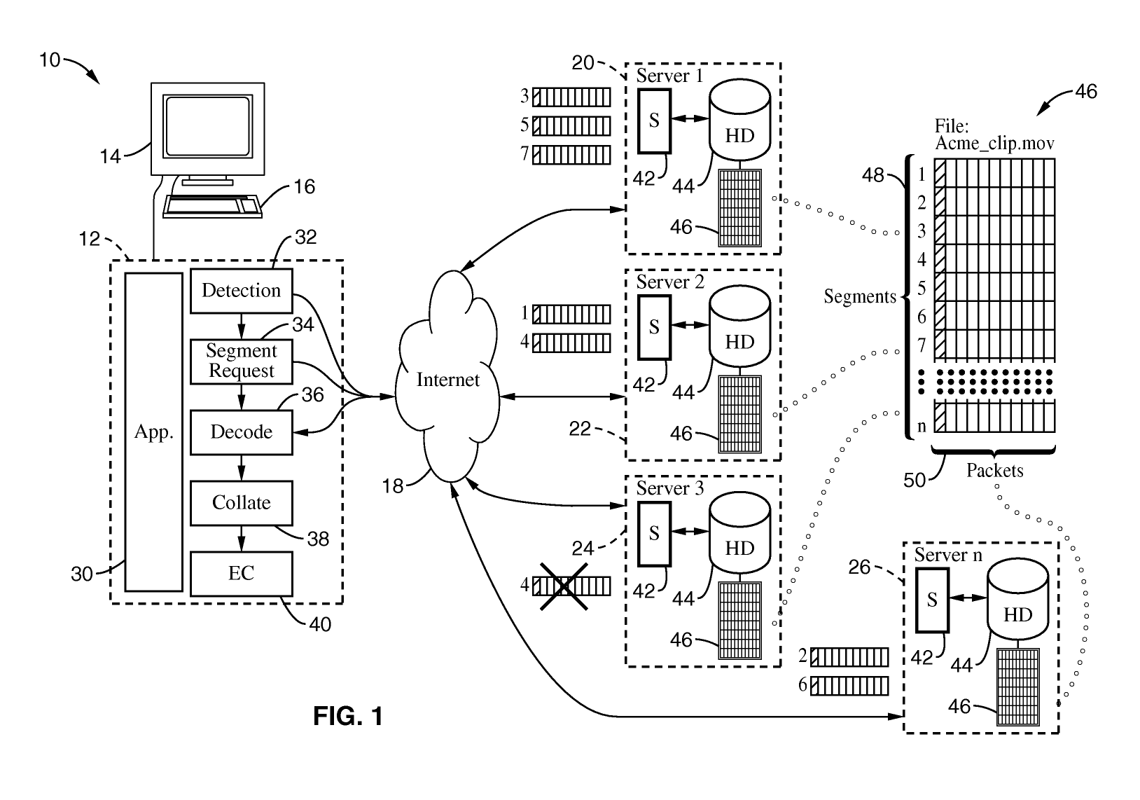

Referring more specifically to the drawings, for illustrative purposes the present invention is embodied in the apparatus generally shown in FIG. 1 through FIG. 6. It will be appreciated that the apparatus may vary as to configuration and as to details of the parts, and that the method may vary as to the specific steps and sequence, without departing from the basic concepts as disclosed herein.

The system and method described herein, when implemented across peers operating over the Internet, or similar wide-area network, allows for real-time streaming transport of media content elements.

FIG. 1 illustrates a streaming system embodiment 10 according to an embodiment of the present invention. Preferably the system is implemented over a peer-to-peer network in which the devices can be either clients or servers, although it can be implemented with one or more fixed clients or servers. As the system is particularly well-suited for use in the peer-to-peer environment, the following descriptions are so directed.

The figure represents network-enabled devices coupled in a peer-to-peer configuration on the Internet, references to client or server are indicative of the role of that specific network device for a particular set of transactions/communications, and not limiting on the practice of those network devices. In this example, a client device 12 (i.e., computer) desires to view streaming media retrieved from peer devices (i.e., computer) on output device 14 (e.g., display, audio system, and so forth). Typically, as each device comprises a personal computer (PC) or similar user-interactive network-enabled device, it is shown with keyboard 16. However, it should be appreciated that other devices can be used, for example a television with attached hard disk drive, wherein a keyboard is not necessary. For the sake of simplicity, the remaining devices 20, 22, 24 and 26, which are configured to communicate with device 12 over network 18, are not shown with a display or keyboard, though they may be incorporated for any given application.

As the system and method described herein is utilized across the Internet, it will be appreciated that any number of devices can be involved in the peer-to-peer operations. To assure clarity, only a representative sample of a system is shown, in particular containing 1^{st}_server 20, 2^{nd}_server 22, 3^{rd}_server 24, and n^{th}_server 26 shown coupled over network 1 8 to client computer device 12.

The client device is shown with application program 30, detection module 32, segment request module 34, decode module 36, collate module 38 and error correction module 40. These will be subsequently described in greater detail.

Server 1^{st}_server 20 is shown with a server computer 42 and a data repository 44, such as a hard-disk drive or other data storage device. A media data structure 46 is shown being retained on the data repository for access by other peers on the network.

In the expanded view of data structure 46 a movie is shown as media content element: “ACME_Clip.mov” which in this example is configured as a plurality of segments 48, shown as segments 1, 2, 3, 4, 5, 6, 7 . . . n. Each segment contains a plurality of packets 50 as well as preferably containing a segment identifier, such as contained in a segment “header” (shown as the shaded portion and not confused with a packet header). The segment identifier contains information which is utilized in collating the assembled segments into a proper order. It will be appreciated that the segment information may also include additional information, such as the total number of segments, other information about segments/media file, information needed for correcting errors, and/or information for executing encryption/decryption schemes and so forth. In one implementation, the segments can be stored as subfiles, for example “ACME_Clip_{—}1.mov”, “ACME_Clip_{—}2.mov”, “ACME_Clip_{—}3.mov”, . . . “ACME_Clip_n.mov”, wherein no additional file manipulation primitives are necessary for extracting the segments from the hard drive, or other form of media storage. Although shown containing a fixed number of packets and having a segment identifier in a segment header, it should be appreciated that the number of packets need not be fixed and that the mechanism utilized for segment identification need not be retained in a header packet at the start of a segment.

Media content, containing the plurality of segments, is stored on devices 20, 22, 24, 26 and so forth as shown. This storage can take place explicitly (i.e., with intent to provide accessibility) or implicitly (i.e., arising naturally as the system performs its normal duties), or as a combination of explicit and implicit storage.

Server programming operable on each device (e.g., 20, 22, 24, 26) is configured to allow a client to retrieve selected segments of media on the device, such as those which have been placed in a public folder or have otherwise been made accessible to external client devices. When retrieving a segment, server programming is configured for retrieving the separate packets from the data storage system and communicating them over the Internet to the requesting client device.

To aid in understanding the operations of the system, function elements within the client side, as represented by computer 12, are now described. These function elements are preferably implemented as programming executable on the underlying processor, or processors, although any or all portions could be augmented with hardware without departing from the teachings of the present invention.

An application 30 generates a request for a specific element of media content, in this case ACME_Clip.mov. An application program 30 is shown through which the streaming media request is considered to have been created. It will be appreciated that although shown as a single entity, any number of applications, library functions, plug-ins, drivers, and so forth may be involved.

The client application detects, such as through detection module 32, which of the available servers contain the desired media and preferably the latency and/or bandwidth availability on these peer devices which are acting in this case as servers. It will be appreciated that this function can be implemented simply as a means of detecting from which peers the streams are available, or to any desired complexity wherein statistics are maintained on latency, latency variation, error rates and so forth toward optimizing use of the plurality of peer devices.

First, the client needs to determine from which peers the media object can be obtained. This can be performed through the use of an availability list, or other data structure. It will be appreciated that this list can be created in any desired manner, for example by an original content source that tracks access to its media and requires that users of the media make it available on their own systems. The address need only comprise a list of net addresses, however, implementations of the invention can utilize additional fields to improve streaming efficiency.

By way of example and not limitation, each record of the list may comprise a net address, more accurately called a universal resource locator (URL), for the peer containing the media content of interest, as well as a location code, and an optional authorization code. The location information provides some level of indirect latency information, wherein the system can check local peers prior to more remote peers. The use of an authorization mechanism, such as a code, allows the prospective server peer to recognize and identify the source or nature of selected accesses, thereby increasing security. It should also be appreciated that other data can be incorporated in the record, including expected latency or values from which latency can be estimated (e.g., connection type, PC hardware information, and so forth). Alternative methods may also be utilized for determining content availability, such as checking with a limited number of candidate servers. From this information the client determines at least two servers, and more preferably at least three servers that possess the desired content element. It will be appreciated that the number of available servers in combination with the expected packet service throughput of those servers will determine if full streaming of the media can be supported, and the level of buffering required.

According to this method, the cumulative transmission rate from this subset of servers is maintained at a data rate that exceeds the data rate at which the content element is encoded (i.e., playback data rate). It should be noted that when the content is available on only one server, the primary advantages of the present approach are not realized, although depending on the bandwidth of the server the media content element can still be retrieved subject to long delays and/or a higher drop-out probability.

It should be understood that the overall latency of a server is the agglomeration of different latency ‘contributions’. A first form of latency is a “transmission latency” which is determined in response to the level of network interconnection and ISP delays that exist between the client and server, these delays being associated partly with the degree of physical separation on the network. A second form of latency is based on the responsiveness of the server, and for lack of a better term we refer to this as “server utilization latency”. The responsiveness of the server generally being a factor of how busy is the server (wherein the term utilization), what is the speed of the system itself and in particular its media access device, what is the priority given to performing the serving function, and so forth.

Detector module 32 can be configured to try and model the latency profiles of the servers, so as to optimally make use of their resources so as to prevent stream drop-outs which disrupt proper real-time stream playback. In one implementation, the programming engages in a dialogue with any server that can provide the desired media stream; for example acquiring information on server use (e.g., user at the console indicating higher levels of latency variability, or level of application activity), the general file server rate of the device (e.g., based on hardware constraints), the priority being placed on servicing the requests, the number of server requests pending, the available bandwidth for servicing the requests, or other parameters either separately or in various combination with one another.

A segment request is generated, such as from segment request module 34, preferably in response to transmission performance so as to optimize the pattern of segment retrieval from the available media sources. Important aspects of transmission performance can include: latency in processing requests, reliability/variability of request processing, and so forth. It will be appreciated that the segments are preferably retrieved from the devices in an attempt to prevent streaming drop-outs in which the next segment of playback does not get received and processed prior to playback completion of the preceding segment. In order to reduce the incidence of drop-outs, the available servers are preferably utilized strategically, wherein segments being retrieved for more immediate use are retrieved from servers with lower latencies and high reliability, and wherein segments needed less urgently (greater temporal playback displacement) can be retrieved from servers having increased latency and/or reduced reliability (or higher levels of estimated latency variation).

The reliability/variability factor involves estimating variation in latency, so for the sake of simplicity the term latency will be considered to include estimating the reliability, or conversely the expected variability of service. The segment request module 34 is therefore, preferably responsive to changes in latency of the servers, (preferably tracking this variance as well as to improve future server predictions) wherein as playback time approaches it can mitigate against drop-outs by duplicating any pending request on another server, such as a local one, to assure that the packets of a segment are retrieved in sufficient time to support sequential playback. In addition, to increase reliability and to decrease the probability of dropouts, the same segment may be requested simultaneously from more than one server.

Transmission performance according to the present invention can be determined in response to a number of different types of information, including but not limited to: server status information, measurements, negotiations, estimations, or any desired combination of status information, measurements, negotiations, and estimations. In some instances, status information can be retrieved from the server on hardware configuration, utilization levels, mode of operation, available bandwidth, latency, or any combinations of the foregoing.

Negotiation can overlap the use of status information, yet connotes a more active interchange between the devices, such as a process in which the client negotiates factors relating to acquiring higher bandwidth and/or reduced latency operations. One example has already been noted in which an authorization from an authorization field of the list is used to denote the source or reason for the request. For another example consider the case where the device of User_A has a preferred relationship with User_G (i.e., inner-circle, same workgroup, or similar) and upon providing identification information is provided with a higher priority service by the device of User_G in response to this “negotiation”. Other examples can be considered wherein the interaction between the peers results in changing the available service level and thus latency.

Latency estimation is generally considered herein as a process by which the client generates estimates of transmission performance from the available data (e.g., hardware; status and utilization information from the server; historical information based on prior interactions with the server; default values established for the servers as a class; location of the server; age of the entry on the listing of servers; current measurement data; and any other available data). It should be noted that estimations preferably operate in concert with all available data, although for simplicity the latency estimates can be based on any desired subset of the available information. In addition, much of the available data is not in the form of a latency value, yet may be used to estimate a latency value. Still further, estimation is utilized to generate a usable latency estimate from a plurality of available data elements which does not necessarily comport with one another, wherein the estimate process may incorporate selective data use (e.g., most reliable indicator), interpolation, averaging, and other data reduction techniques.

Measurement of transmission performance comprises the collecting of information about the latency to which packets are served to the client from the server. Measurements preferably commence by registering transmission performance when sending a request for the segments of the given media content. The measurements can categorize different aspects of performance, such as delay to first returned packet (initial delay) and average delay between packets (inter-packet delay), or other categories of measured performance (e.g., maximum packet delay, median packet delay, packet delay for n standard deviations, and so forth). The preceding example of initial delay compared with inter-packet delay can provide important information to gauge where to send the requests. It will be noted that a very fast server located at a distance will provide a large initial delay with a possibly low inter-packet delay depending on the specific networking protocol; while a busy and slow device located nearby could provide a short initial packet delay, yet be subject to a high inter-packet delay.

It will be appreciated that if the packet rate diminishes while fulfilling a request, and/or if a short time remains before the segment is to be output in playing the stream, then the client according to the invention can generate a duplicate request to another server. The ability to discern initial delay versus inter-packet delay (average, and variance) can be helpful for establishing thresholds to determine if a server is operating as expected, and thus determining when to duplicate a request to another server.

In considering drop-outs, it must also be considered how to deal with the scenario in which some packets of a segment are received, but then the packet rate drops or stops, indicative of a likely drop-out. In one implementation of the system, the programming of the server as well as the programming of segment request module 34 of the client, are configured to allow the client to request a specific range of packets within a segment, for example to collect remaining packets of a segment when communication from another server is lost or slows down after a portion of the packets have been retrieved. (Note—not a relevant concern for an implementation having segments encoded using erasure or Fountain codes prior to transmission, as in this case the original segment may be reconstructed from any subset of packets from the encoded segment.) This option is particularly suited for servers which send the packets sequentially from some place in the segment, then wrapping around the buffer as necessary, to complete packet sending. It will be appreciated that when packets within a segment are randomly retrieved then it can become more difficult to specify packet needs within a segment from another server, and hence random retrieval is typically used only when segments are encoded using erasure or Fountain codes prior to transmission.

In one mode of the system (e.g., subject to server-side acceptance of these conditions for this client or situation) the method of packet retrieval by the server can be “selected” by the client. For the sake of clarity the following will consider the simple case of normal priority versus an expedited priority. By way of example and not limitation, in a normal retrieval scenario the file system on the server can read the packets of the segment as they become available on the media, such as on a hard disk drive, and send these packets as they become available, or alternatively buffer these packets up until all the packets, or at least the starting packet (e.g., segment header packet or first packet) becomes available, at which time it commences packet transmissions to the client.

In contrast to the above an expedited retrieval is one in which the server retrieves and sends the first packet, followed by the second packet and so forth. In this scenario, assuming data is contained on a rotating media, retrieval of segments under normal priority is typically more efficient for the server but exhibits increased latency (for any specific packet), whereas the expedited delivery can aid in limiting streaming dropouts, or compensating for changing server loads and status by which packets from requested segments are unduly delayed. It should be appreciated that any desired number and type of retrieval priority schemes can be adopted within the system without departing from the present teachings.

Packets received from the servers are decoded, such as in decoder module 36. The decoding primarily converts the packets from communication format to the desired streaming format which will be used, and can include any desired decryption and decoding processes to fulfill that object. The packets are decoded into their proper segments. The segments being collected are collated, such as in collator module 38, so that sequential segments become available as packets of the segments are received from various servers.

An error correction module 40 is shown for handling lost or faulty packets in the segments. This error correction can be considered to be at a higher architectural level than conventional packet error handling which is executed below the network layer of the IP stack. When packet errors arise that cannot be corrected at the lower level (e.g., bit corrections), then the segment request module 34 is notified immediately so that a duplicate of the errored packet can be retrieved, insofar as sufficient time remains to allow for retrieval from at least one server. When segments are encoded using erasure or Fountain codes as in one option of this invention, requests for retransmission are not usually required.

Considering segment packet retrieval as shown in the figure, a series of segment blocks are shown being transmitted by each of the peer server devices. Although shown as a series of contiguous packets for the sake of illustration, it should be appreciated that each packet is sent asynchronously over the Internet and is subject to a somewhat non-deterministic delay. The following description outlines a hypothetical series of requests being generated by peer 20 operating in a client mode, and served up by peer devices 20, 22, 24 and 26 operating in a server mode. In order to simplify description, the following outlines request generation and service, but does not detail the collating and use of the received segments by application 30 utilizing the streaming media.

In response to detection module 32 detecting that 2^{nd}_server 22 has the shortest latency, a request is sent from segment request module 34 to 2^{nd}_server 22 for the first segment (segment 1) of ACME_Clip.mov. Based on latency considerations, requests are sent to n^{th}_server 26 for the second segment (segment 2), sent to 1^{st}_server 20 for the third segment (segment 3), and sent to the 3^{rd}_server 24 for the fourth segment (segment 4).

Packets within first segment (segment 1) begin arriving from 2^{nd}_server 22 and are decoded. The time at which application 30 can begin using the collected segments, for outputting the stream being retrieved, can be established by any desired means, such as based on having a predetermined number n of available segments fully decoded and collated, or a number of segments decoded as based on the number of available servers and the average latency wherein the drop-out probability is sufficiently curtailed.

Based on a predetermined outstanding segment request depth of four (an arbitrary setting for this example), a request is sent for the fifth segment (segment 5) from 1^{st}_server 20. It should be appreciated that any desired mechanism can be utilized for determining the timing of request generation and the number of requests which can be outstanding at any one time. The example value of four is provided for simplicity of description. It will be recognized in general that for a typical length stream (e.g., fifteen minutes up to or beyond 120 minutes in length) not all segment requests would be generated at the same time as this would lead to undue packet congestion. As enough time remains before the fifth segment (segment 5) is needed by application 30, the segment request has been sent to a device having a longer latency than 2^{nd}_server 22, or n^{th}_server 26, thus saving 2^{nd}_server 22 in reserve.

A short time later, packets within the second segment (segment 2) and the third segment (segment 3) are being received and decoded from their respective servers. A short time later packets within the fourth segment (segment 4) are being received from 3^{rd}_server 24.

At a later time all packets of the first segment (segment 1) have been received and decoded, and packets continue being received and decoded for the second and third segments. However, the system determines that no more packets are being received from 3^{rd}_server 24, or that they are being received too slowly given the amount of time available until they are needed. Therefore, a duplicate request is sent out for the fourth segment (segment 4) to 2^{nd}_server 22 based on latency and trustworthiness. If specific packets can be requested, then only the remaining packets of the fourth segment need be requested.

The remainder of packets within the third segment (segment 3) are received and decoded. A request for a sixth segment (segment 6) is sent to n^{th}_server 26 from which the packets of the second segment (segment 2) have been largely received.

Packets within the fifth segment (segment 5) are being readily received and decoded from 1^{st}_server 20, wherein a request for the seventh segment (segment 7) is sent to 1^{st}_server 20.

The process continues with packets of the segments, through the n^{th} segment, being received, decoded, collated and output in the media stream associated with application 30. The above process provides an indication of the dynamic nature of the segment requests and collection of packets within each of the segments. The system adapts the requests being generated in response to the availability of servers and their association conditions and observed latencies, so as to minimize the possibility of drop-outs.

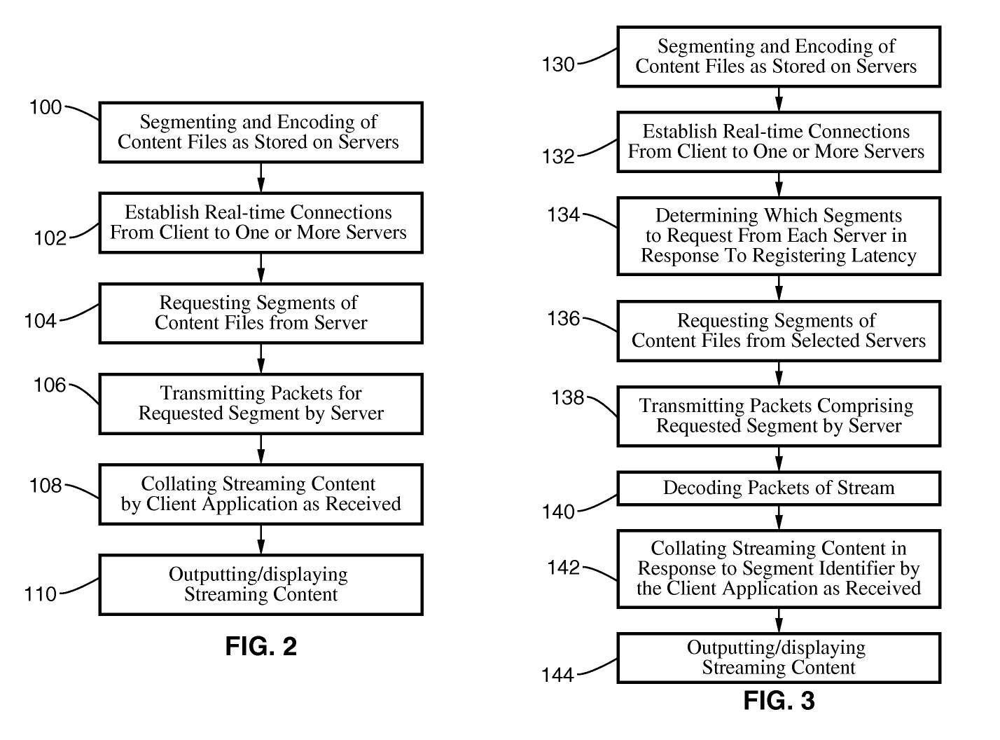

FIG. 2 illustrates an example embodiment of the method of performing peer-to-peer streaming of media content elements. Segmenting and encoding of content elements is performed, as represented by block 100, either before the files are stored, as they are being stored, or after they are stored (e.g., direct conversion, or converting a copy) on a server (e.g., peer operating in the capacity of a server) within the plurality of devices which can communicate over the Internet.

In block 102 real-time connections are established from the client to one or more servers wherein the availability of the content element is determined and also latency information is preferably collected. As per block 104, segments of the streaming media content element are requested from one or more servers. As the requests are serviced, servers transmit packets for requested segments as indicated by block 106. It should be appreciated that the packets of a segment can be sent in any desired order by the servers.

The order of packet sending is described by way of example and not limitation as any of the following, or combinations thereof: (1) by order in the segment, thus reducing assembly overhead; (2) by order of retrieval from media, thus reducing buffer overhead; (3) by priority of need from the client, thus minimizing drop-out risk for the application; (4) in response to a specified range of packets within the segment, thus filling in for bad or missing packets within a segment; (5) randomly; or (6) by other mechanisms and combinations thereof for determining the order of sending the packets within a segment.

In one mode of the invention, the order of packet retrieval requested by the client can be modified during packet retrieval, such as changing priority in response to immediate packet needs being fulfilled, and so forth.

At block 108 the packets of streaming content are collated and prepared for use by the client application. It will be appreciated that the packets typically need to be decoded into a stream format and ordered within the segment and the segments themselves ordered for use in the stream. Finally, as per block 110 the outputting and/or displaying of the streaming content commences while streaming content continues to be received.

FIG. 3 illustrates an example embodiment containing additional detail on the steps involved in peer-to-peer streaming. In block 130 the streaming media is segmented before, at the time of storage, or after being stored on servers. Network connections are established in real-time from the client to one or more servers at block 132 wherein information about the availability of the desired streaming media and latency information is collected. In response to the information about projected server latencies, it is determined from which peer each of a number of segments are to be requested as per block 134. In block 136, requests are generated to selected servers (e.g., peer devices acting in the capacity of servers) for the streaming media segments.

As shown in block 138, the requested packets for the segments are transmitted from the servers. It will be appreciated that as packets are being received for a given segment, that requests for additional segments are being sent to one or more servers based on their performance with respect to the time available before the segments are needed for output. The received packets are decoded at block 140, after which collating of the segments is performed based on the segment identifier as per block 142. It will be appreciated that the packet collation may be performed at this level, but more preferably the execution of that functionality is retained by the lower level IP stack. In block 144 the streaming content is output and/or displayed, such as by the application which originally requested retrieval of the streaming media.

It should be understood in the above descriptions that for the sake of simplicity the conventional aspects of packet processing are not described. In addition, it will be recognized by one of ordinary skill in the art that a number of variations of: (a) latency detection, (b) segment request order selection, (c) segment request depth selection, (d) segment service error handling, (e) decoding, (f) collating, (g) determining when to commence release of segments to the stream, and so forth can be implemented without departing from the teachings herein.

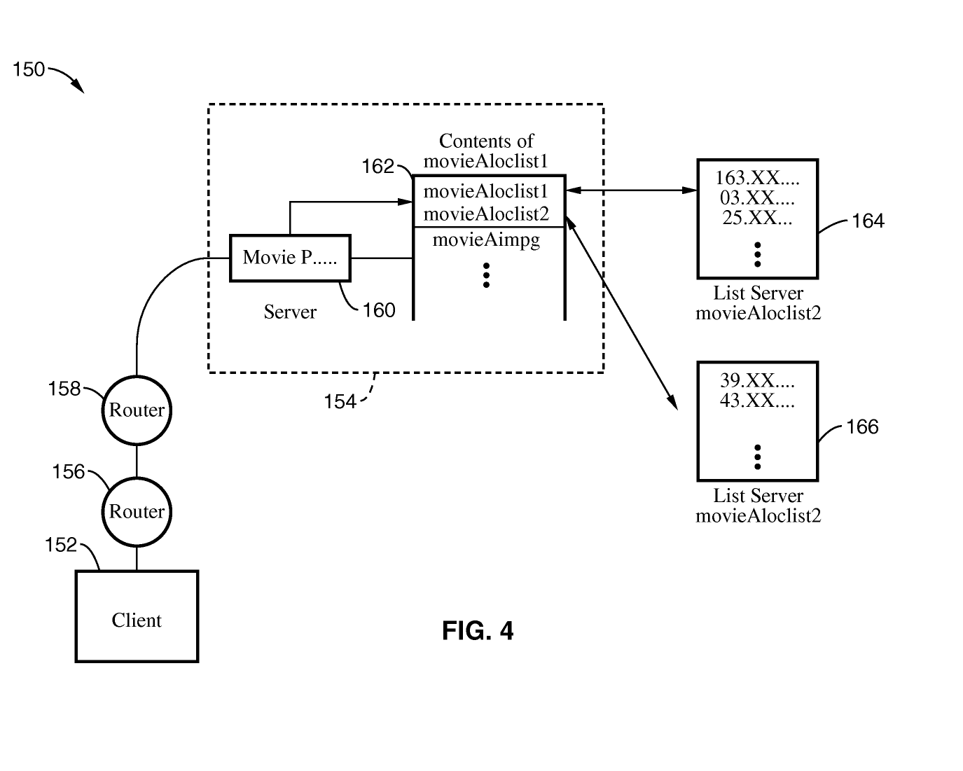

FIG. 4 illustrates another embodiment 150 of the peer-to-peer streaming system as implemented in a client program and a server program. The client program runs on a device 152 upon which the user has activated or requested to display a given stream, and a server program 154 runs on the one or more remote devices that will provide the stream to the client program. It will be noted that the client and server can be separated by any number of routers, for example routers 156, 158. The client and server represent two nodes on the Internet, though it should be appreciated that the nodes may be peers wherein each may be able to fulfill both client and server processing. The implementation is subject to a number of variations.

The user on client device 152 will attempt to access a media file (hereinafter referred to as a movie file as this is a typical application), such as “movieA.dvs”. The “.dvs” extension identifies the file as being of the “distributed video streamer” format which is introduced in this invention. The user attempts to view movieA.dvs by starting the DVS application and attempting to open an Internet link to movieA.dvs, or by clicking on a link to movieA.dvs, which launches the DVS application, and so forth.

The DVS client application opens movieA.dvs 160 on whichever server it is located on the Internet. The first part 162 of the file movieA.dvs has a list of other servers 164, 166 on the Internet called DVS Location List Servers that contain files, which in turn contain the Internet addresses of all other devices on the Internet that have copies of the file movieA.dvs.

It should be appreciated that the DVS application can also be implemented to access a web site containing the names of all available movies (e.g., movieA.dvs, movieB.dvs, etc.) together with the Internet addresses of all devices that have copies of each movie. The web site will typically be implemented on different devices across the Internet in order to avoid being a single point of failure. Variations and combination of these approaches may be utilized for determining the locations from which the segments of the media can be accessed.

The DVS client application running on the client side 152 (e.g., computer of the user) is provided a list of n devices connected on the Internet from which movieA.dvs is available. Information is gathered from the nodes (acting as servers) on which the movieA.dvs is available, wherein these n devices can be selected according to any desired mechanism, such as randomly, from the list of devices in the DVS Location List Server file.

The DVS client application then queries each of the n devices (referred to as servers) to gather information about movieA.dvs, such as is the movie still available on these devices. It also queries each server to determine the data rate s(i) that the server is willing to provide. The data rate s(i) can take into account what the owner/user of that server is willing to commit to servicing remote DVS applications, and other factors as desired. The client side application then measures performance from that server, such as using brief streaming tests, to determine the actual throughput t(i) possible from the server to itself. The performance testing is beneficial because the Internet infrastructure itself may impose limitations on the bandwidth. The transmission latency for data transmitted from the server to the DVS application on the client is also measured.

The DVS client application then requests streaming of the movieA.dvs data from a subset of the n servers. For each server, the DVS client application requests the server to transmit data at a certain data rate r(i), where SUM(r(i))>=f(MovieRate), where MovieRate is the total data rate for MovieA.dvs. The requested data rate is less than the lower of s(i) and t(i) as defined above. The server is also requested to transmit data delayed by a desired amount, such as d msec, wherein the value of d may be zero. This metric is utilized to ensure that data arriving from different servers on the Internet arrives at roughly synchronized parts of the stream, and hence servers whose data is received with substantially lower latency compared to data from other servers are in fact requested to implement a suitable delay prior to transmission.

We now consider what is meant by f(MovieRate). MovieRate is the rate of the original stream, such as may be encoded in the AVC codec for example. Let us assume the stream is in standard definition AVC format, at 1 mbps. The value of f is an overhead factor to overcome encoding efficiencies, packet losses and so forth to assure that the movie can still be output in real time.

In one mode of the invention, the encoding utilized is fountain encoding which is applied to the source file (a variation is discussed later). A file with fountain encoding and protection against 20% packet loss would typically increase in size about 20%, and hence the encoded movieA.dvs would need to be streamed at f(MovieRate) of about 1.2 mbps. Each client is requested to stream movieA.dvs data at a data rate of r(i), and the sum of these streams is shown above to be equal to or greater than f(MovieRate). By being preferably somewhat higher rate than f(MovieRate), redundant data can be retrieved from these servers to compensate for worst case error conditions or the complete loss of one or more servers during the streaming process. It will be appreciated that the value of f can be defined and/or refined in response to any desired number of characteristics without departing from the teachings of the present invention.

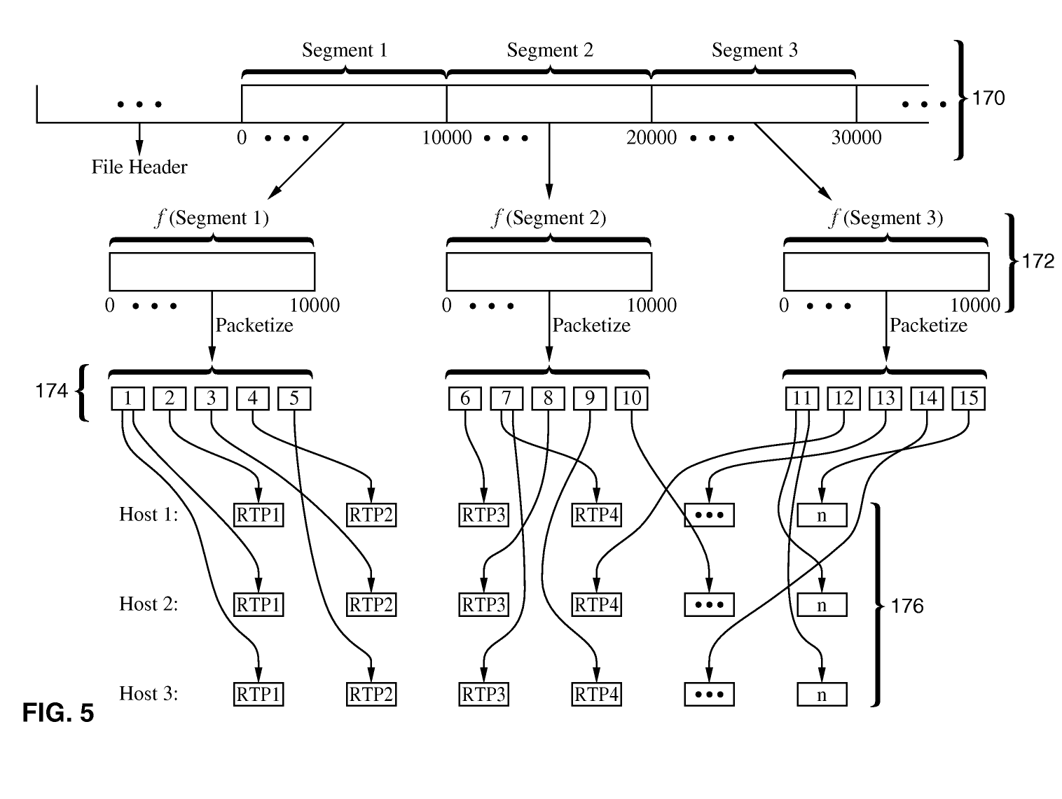

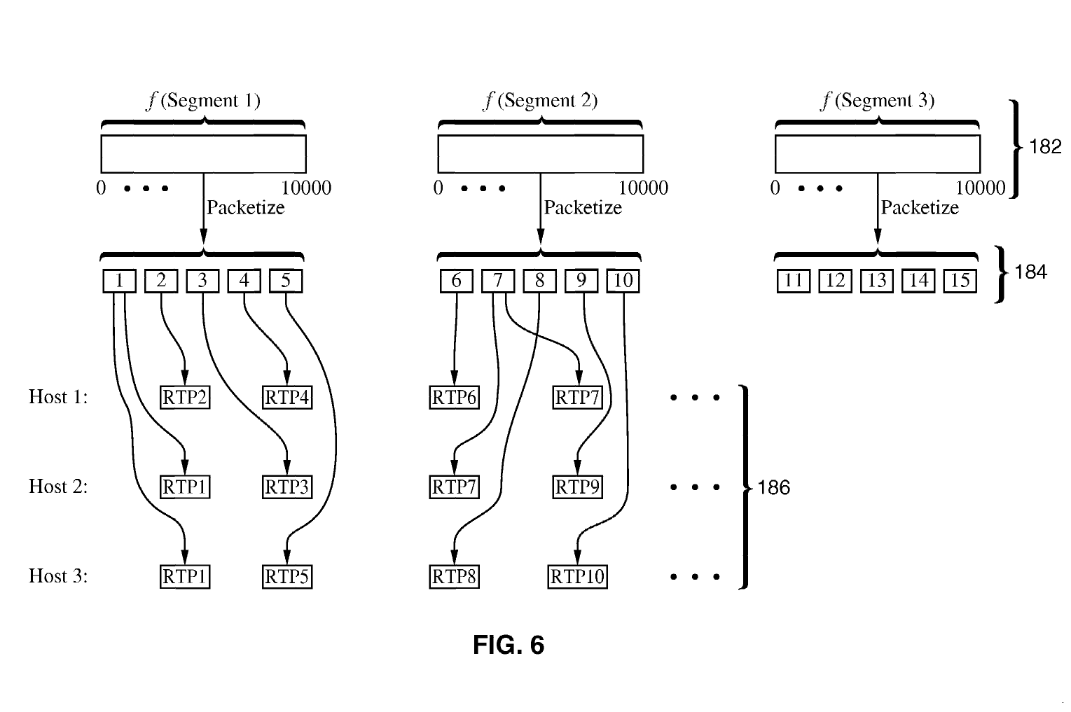

FIG. 5 and FIG. 6 illustrate a mechanism by which data within the movie is selected for transmission at each of these n servers. FIG. 5 represents what we will call our normal RTP transmission protocol. The AV content of file movieA.dvs on each server is divided into a number of segments 170, for example: segment 1, segment 2, segment 3, and so forth. Each segment is then encoded 172, such as using a fountain code f(segment 1), f(segment 2), and the like as shown. Note that all servers perform these tasks, and all servers will obtain the same results for f(segment 1), f(segment 2), and so forth.

Next, each segment is packetized 174 depending on the medium and network protocol. For example, for IP and Ethernet, each packet size could be 1000 bytes. Each server selects a suitable number of 1000 byte packets (as per this example) during each segment f(segment X), to meet its requested data transmission rates. Each server may select packets from each segment according to any desired mechanism. Examples of selection mechanisms include by: availability, access order, priority, random, pseudo-random (e.g., pre-determined lookup table based on requested server index and requested stream rate), and so forth. To simplify explanation, utilization of a random selection mechanism will be generally described by way of example for determining which packet (e.g., by packet number) is to be transmitted so as to minimize redundant transmissions across servers. All selected packets for each server are then transmitted using the applicable network protocols, which in the example case are IP protocols, such as RTP over UDP. Note that each RTP packet is given an index relative to its own server, as is normally the case for RTP, and hence the RTP packets are labeled 1, 2, 3, . . . n, and so forth.

At the client, the DVS application receives the streams 176 from the various servers, listed in this example as Host 1, Host 2, and Host 3. It can be seen that the various packets from each segment are transmitted by one or more of these hosts. Once received, fountain decoding is performed on the packet stream to obtain the original AV codec stream which also results in discarding of redundant data and execution any error correction, such as forward error correction, and then the client application displays the stream.

The DVS client application may initiate connections to new servers as needed during the streaming session since performance from currently used servers may decrease, over vary, with respect to time. In addition, the DVS client may use servers with minimum route overlap in order to reduce correlation of bandwidth variation over time for data from the different servers. It will be appreciated that packet routes for different servers may be determined using back transmitting packets with increasing TTL (time-to-live) values to determine routers along the path.

FIG. 6 illustrates a variation of this invention in which the normal RTP transmission protocol described above is replaced by a novel approach for what will be called a “distributed RTP” implementation. Instead of each server numbering RTP packets based on the number of previous packets transmitted from the same server, RTP packets are numbered to be globally consistent. The media is segmented 182 and then packetized according to a global numbering schema 184, for transmission by the hosts 186.

As an example of a global numbering scheme consider that an RTP packet numbered “1” transmitted from server called Host 2 would contain the same data as an RTP packet transmitted from server called Host 3 that also was numbered as “1”. This globally coherent numbering allows routers close to the client device to be modified to discard redundant packets before transmission of these packets to the client, simply by inspecting the RTP indices. Hence, the client CPU load resulting from redundant packets is decreased, and the bandwidth requirements of the link from the last-leg routers to the client device (e.g., over the xDSL link) is also decreased, while the approach reduces client overhead for identifying and discarding redundant packets.

This “distributed RTP” method allows yet another alternative implementation without the use of fountain encoding. In the most simple variation, no fountain encoding and no forwarding error correction is performed, wherein the raw actual AV data is itself transmitted from the servers to the client. The client DVS application can request redundant data from multiple servers, and those packets that do finally arrive near the client or routers near the client, and which are redundant can easily be identified and discarded.

The use of redundant transmission (in addition to the use of forward error correction when using fountain encoding) makes it unlikely that the proper contents will not be received. However should a packet be missing, and should it be impossible to recreate this data from other received data, then the client may request retransmission of the missing packet. Typically retransmission is requested from the server with the smallest RTT (round trip time) transmission latency to the client.

It should be appreciated that while it is not always critical to receive flawless data for AV streaming purposes, it is necessary (or at least highly beneficial) that the receiving client store a flawless version of the received file so that it can be provided in the future to other devices (e.g., the client device will be expected at some time to play the role of server to other devices). In order to assure receipt of all necessary packets, client devices must be motivated to stay on the Internet after they have completed their own streaming and downloads. This motivation may be achieved, for example, by allowing clients to download from other clients at data rates that depend on the data rates at which they themselves have provided content to others. After a download, a client may notify the fileListServer of the data rates offered and actually provided by the various servers that were used for the download, and optionally other information, such as whether the client now has a shared full version of the downloaded file.

Recall that initially the client is provided a list of n servers from which it may choose a subset. Within these n potential servers, the client may choose to stream from a subset of p servers. However, the client will typically continue to monitor performance to other of the (n-p) servers who may provide greater bandwidth in the future, and may dynamically request data from these additional servers as they become available. Previous servers with poor performance may similarly be disconnected by the client during a streaming session.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for collecting streaming content from over the Internet, comprising:
means for a client to determine the availability of a given streaming content element within a plurality of peer devices configured for communicating with the client over the Internet;
wherein said given streaming element is retained within the plurality of peer devices as a plurality of segments, each of which contains a plurality of data packets and a segment identifier;
means for requesting said segments of the given content element from any of the plurality of peer devices based on transmission performance;
means for establishing real-time connectivity with one or more peer devices, from within the plurality of peer devices, from which are collected the packets within each of said segments of the given streaming content element as transmitted over the Internet; and
means for preparing and ordering the collected packets and segments into a non-segmented streaming output of said given streaming content element.

2. An apparatus as recited in claim 1, wherein the Internet is a wide area network that utilizes IP protocols.

3. An apparatus as recited in claim 1, wherein said client is a network-enabled computer device configured for utilizing a peer-to-peer protocol that allows streaming of content elements over the Internet.

4. An apparatus as recited in claim 1, wherein said transmission performance is determined in response to server status information, measurement, negotiation, estimation, or any desired combination of server status, measurement, negotiation and estimation.

5. An apparatus as recited in claim 1, wherein said means for a client to determine the availability of a given streaming content element within the plurality of peer devices comprises programming for reading the members of a list to which said streaming content element has been stored, or provided for the purpose of storage.

6. An apparatus as recited in claim 1, wherein said means for establishing real-time connectivity comprises the use of a real-time transport protocol established with one or more of the peer devices.

7. An apparatus as recited in claim 1:
wherein said segments and/or data packets are encoded prior to transmission; and
wherein said means for preparing and ordering the collected packets and segments is configured for decoding the packets and collating the segments into a streaming output of the given streaming content element.

8. An apparatus as recited in claim 7, wherein said encoding comprises fountain code encoding.

9. An apparatus as recited in claim 1, wherein said data packets are numbered according to a distributed RTP implementation utilizing global packet numbering wherein identical packet portions of the original media can be detected from comparing their respective packet identifiers.

10. An apparatus for collecting streaming content from over the Internet, comprising:
a network-enabled computer device configured for communicating with a plurality of other network-enabled computer devices over the Internet;
programming executable on said network-enabled computer device for,
determining the availability of a given streaming content element within the plurality of other network-enabled computer devices,
wherein said given streaming content element is retained within the other network-enabled computer devices as a plurality of segments, each of which contains a plurality of data packets and a segment identifier,
requesting said segments of the given streaming content element from selected network-enabled computer devices within the plurality of network-enabled computer devices based on estimated and/or measured transmission performance of the network-enabled computer devices,
establishing real-time connectivity with the selected network-enabled computer devices from which are collected the packets within each of said segments of the given streaming content element, and
preparing and ordering the collected packets and segments into a non-segmented streaming output of said given streaming content element.

11. An apparatus as recited in claim 10, wherein said segments and/or data packets are encoded prior to transmission.

12. An apparatus as recited in claim 10, wherein said segments and/or data packets are encoded according to a fountain code encoding prior to transmission.

13. An apparatus as recited in claim 10, wherein said data packets are numbered according to a distributed RTP implementation utilizing global packet numbering wherein identical packet portions of the original media can be detected from comparing their respective packet identifiers.

14. An apparatus as recited in claim 10, wherein the Internet is a wide area network that utilizes IP protocols.

15. An apparatus as recited in claim 10, wherein said network-enabled computer device is configured for utilizing a peer-to-peer protocol that allows streaming of content elements over the Internet.

16. An apparatus as recited in claim 10, wherein said preparing and ordering of the collected packets comprises collating the packets and segments of the streaming content element as received from the selected network-enabled computer devices from which segments of the streaming content element have been requested.

17. An apparatus as recited in claim 10, wherein the selected network-enabled computer devices are configured to transmit, without conflict, packets within a segment of the streaming content element using IP protocols.

18. An apparatus as recited in claim 10, wherein the selected network-enabled computer devices create packets of the streaming content for reducing the transmission redundancy by using a distributed real-time transport protocol (RTP).

19. An apparatus as recited in claim 10, wherein estimated and/or measured transmission performance is determined in response to tracking of service latency from the selected network-enabled computer devices.

20. An apparatus as recited in claim 10, wherein said estimated and/or measured transmission performance is selected separately or in any desired combination from the group of transmission performance criterion consisting of server status information, measurement, negotiation and estimation.

21. A method of communicating streaming content through the Internet, comprising:
storing a given streaming content element within a plurality of network-enabled computer devices configured for communicating over the Internet;
wherein said given streaming element is retained within the network-enabled computer devices as a plurality of segments, each of which contains a plurality of data packets and a segment identifier;
determining the availability of the given streaming element within the plurality of network-enabled computer devices;
requesting said segments of the given content element from selected network-enabled computer devices within the plurality of network-enabled computer devices in response to estimated and/or measured service latency of the network-enabled computer devices;
establishing real-time connectivity with the selected network-enabled computer devices from which are collected the packets within each of said segments of the given content element; and
preparing and ordering the collected packets and segments into a streaming output of said given content element.

22. A method as recited in claim 21, wherein said service latency is determined in response to server status information, measurement, negotiation, estimation, or any desired combination of server status, measurement, negotiation and estimation.

23. A method as recited in claim 21, wherein said client is a network-enabled computer device configured for utilizing a peer-to-peer protocol that allows streaming of content elements over the Internet.

24. A method as recited in claim 21, wherein determining availability of a given streaming content element comprises reading the members of a list to which said streaming content element has been stored, or to which said streaming content element has been provided for the purpose of storage.
